(19) United States
(12) Patent Application Publication
(10) Pub. No.: US 2013/0304927 A1
(43) Pub. Date: Nov. 14, 2013

(54) NETWORK ADDRESS TRANSLATION-BASED METHOD OF BYPASSING INTERNET ACCESS DENIAL

(71) Applicants: MARWAN H. ABU-AMARA, DHAHRAN (SA); ABDULAZIZ AL-BAIZ, DHAHRAN (SA); ASHRAF SHARIF HASAN MAHMOUD, DHAHRAN (SA); MOHAMMAD H. SQALLI, DHARAN (SA); FARAG AHMED AZZEDIN, DHAHRAN (SA)

(72) Inventors: MARWAN H. ABU-AMARA, DHAHRAN (SA); ABDULAZIZ AL-BAIZ, DHAHRAN (SA); ASHRAF SHARIF HASAN MAHMOUD, DHAHRAN (SA); MOHAMMAD H. SQALLI, DHARAN (SA); FARAG AHMED AZZEDIN, DHAHRAN (SA)

(73) Assignees: KING ABDULAZIZ CITY FOR SCIENCE AND TECHNOLOGY, RIYADH (SA); KING FAHD UNIVERSITY OF PETROLEUM AND MINERALS, DHAHRAN (SA)

(21) Appl. No.: 13/471,265

(22) Filed: May 14, 2012

(51) Int. Cl. G06F 15/16

(52) U.S. Cl. 709/227

(57) ABSTRACT

The network address translation (NAT)-based method of bypassing Internet access denial uses NAT as an identity-hiding technique to bypass Internet access denial. The victim network uses NAT routers as a gateway to connect to neighboring networks, and uses a set of non-blocked Internet protocol (IP) addresses as the NAT routers' external public IP addresses. These addresses are not part of the IP ranges registered to the victim network. Rather, they are obtained from a neighboring network. The outgoing packets, therefore, will not be blocked by the malicious ISP, as they will not be recognized as part of the victim network. The method is scalable and has minimal network performance impact. Although NAT introduces some connectivity limitations, these are overcome by using application-layer routing for server reachability behind NAT, and NAT traversal techniques for peer-to-peer (P2P) applications.

### BACKGROUND OF THE INVENTION

1. Field of the Invention

The present invention relates to computer network protocols, and particularly to a network address translation-based method of bypassing Internet access denial by using network address translation as an identity hiding technique to bypass Internet access denial.

2. Description of the Related Art

The Internet is formed from the interconnection of numerous Autonomous Systems. An Autonomous System (AS) is a network that is under singular administrative control. Most Autonomous Systems are operated by Internet Service Providers (ISPs). ISPs are loosely classified into three tiers, based on their size and interconnections: Tier-1 ISPs own large networks that cover one or more than one continent, and they form the core of the Internet. Tier-2 ISPs are smaller networks that mostly cover one or a few countries. Tier-3 ISPs are the smallest, covering a country or a metropolitan area of a country, Tier-3 ISPs provide Internet service to end users, and connect to one or a few larger ISPs for the delivery of their customers' traffic to destinations outside of their networks. Higher-tier ISPs (i.e., tier-1 and tier-2 ISPs) carry not only traffic that belongs to their networks, but also traffic that originates from, or is destined for, one of the networks to which they are connected. Thus, packets that are sent from one end user to another are likely to be carried over multiple different tier ISPs.

Autonomous Systems are interconnected using inter-domain routing protocols. The Border Gateway Protocol (BGP) is the dominant inter-domain routing protocol used in the Internet. Thus, BGP is the inter-AS routing protocol that interconnects ISPs. BGP provides routing information as a set of IP address subnets (known as “prefixes”) and reachability information related to each prefix. Routes in BGP are described as a sequence of Autonomous Systems that traffic traverses to reach its destination.

BGP, however, suffers from many security weaknesses. Many vulnerabilities in the design of BGP have become increasingly critical as the Internet has grown. One of the issues with BGP is the inability to control how traffic is routed through Autonomous Systems. The received prefix reachability paths can only be considered as “promises”; i.e., there is no way to ensure that traffic will actually be routed through these paths. Practically, routers may provide the list of Autonomous Systems that propagated the BGP update messages, which are not necessarily the same as the list of Autonomous Systems traversed by data packets. BGP allows the network to control only which neighbor AS will receive the packet, but not how that neighbor AS, or any other AS in the remainder of the path, will handle that packet. Further, many networks use load-balancing and multi-homing techniques to distribute traffic over multiple links. Thus, the traffic may go through different paths other than the advertised ones, and may go through Autonomous Systems that the traffic originator is not aware of.

This issue does not normally affect the delivery of traffic, as packets will eventually reach their destinations, regardless of the path used. However, many security concerns are raised because of this behavior. Packets may go through Autonomous Systems that the traffic originator is unaware of, as they do not appear in the AS path. The presence of a malicious ISP in any path to the destination results in the potential risk of routing the packets through that malicious ISP.

A malicious ISP can, for example, monitor, record, or even modify packets that are routed through it, performing “man-in-the-middle” attacks. It may also “blackhole” the traffic that belongs to a specific network (referred to as the “victim network”); i.e., drop all the packets originated from, or destined for, the victim network. Thus, it denies providing routing services for that particular network, preventing it from accessing many destinations, namely, the ones that are reachable through paths that go through the malicious ISP. In the following, Internet access denial by malicious ISPs is defined as the process of filtering transit traffic in order to drop packets that belong to a specific network.

The idea of malicious higher-tier ISPs may seem unlikely, since ISPs that perform Internet access denial are risking their reputation, and eventually their business, as they will lose customers. However, there are several reasons that may force an ISP to become malicious and perform Internet access denial against a specific organization or country. For example, Internet access denial can be driven by political motivations, as governments may force ISPs to block Internet access to a specific region or country in an attempt to establish an Internet embargo on that specific region. Recently, many large services and networks have been attacked for political motivations. Additionally, ISPs' routers may be hacked by attackers and reconfigured to drop traffic, which also causes Internet access denial. Although the latter case might be temporary, it still has an impact on the victim network. Further, malicious BGP path advertisements can redirect traffic to malicious Autonomous Systems, an attack technique known as “BGP hijacking”. Such attacks have taken place on numerous occasions, with an AS, mistakenly or intentionally, advertising BGP routes to prefixes that do not belong to it, thus redirecting all the traffic towards that AS.

Most of the Autonomous Systems that form the Internet core are owned by tier-1 and tier-2 ISPs. Internet traffic sent from a host on one network to a destination on a different network is likely to go through multiple Autonomous Systems, of which one or more is a higher-tier ISP. As noted above, in the following, Internet access denial by malicious ISPs is defined as the process of filtering transit traffic for the purpose of dropping packets that belong to a specific victim network. The malicious ISP configures its routers to drop or blackhole some or all of the traffic that originates from, or is destined for, one or more IP prefixes of the victim network. It is assumed that the malicious ISP will use the network-layer information (i.e., source and destination IP addresses) to determine if a packet belongs to the victim network. Malicious ISPs can perform Internet access denial on any IP address blocks, ranging from a single host to an entire country.

The impact of Internet access denial depends on the location, size, and connection topology of the malicious ISP. Lower-tier ISPs can only cause Internet access denial if they exist in the route of the traffic, while higher-tier ISPs may have a larger impact. Since tier-3 ISPs do not act as transit for other networks, they only carry traffic that belongs to their networks. Thus, a malicious tier-3 ISP can only block access to its own network. Hence, the impact of this type of ISP is limited to only a small set of hosts and services. On the other hand, malicious higher-tier ISPs can have greater impact as they can block not only traffic that belongs to their networks, but also all other traffic that passes through them in transit. For example, a malicious tier-2 ISP may block access to its own network, and to all its customer ISPs' networks. Furthermore, Internet access denial by tier-1 ISPs presents a more critical problem. A malicious tier-1 ISP can isolate the victim network and block it from accessing a large portion of the Internet. Because of the major impact that a malicious higher-tier ISP can cause, solutions to the Internet access denial problem are of great interest.

The growing importance of the Internet has motivated many studies on Internet resilience against different types of outages, failures, and attacks. Internet unavailability takes place due to either accidental or malicious causes. Hardware and/or software failures, misconfiguration, and traffic congestion are non-malicious activities that may cause Internet unavailability. Many solutions have been proposed to address these issues in the physical, routing, and application levels.

Malicious activities that may cause Internet unavailability include Denial-of-Service (DoS) attacks, security breaches, terrorist attacks, intentional hardware failures, and deliberate Internet access denial by service providers. Most of the research that has been done in this field targets DoS attacks and security breaches, with very few research efforts being directed towards terrorist attacks and intentional hardware failures. Internet access denial takes place when two conditions are met: packets are routed through a malicious ISP, and the malicious ISP drops these packets. Thus, the Internet access denial problem can be resolved by eliminating one or both of these conditions. Therefore, two classes of solutions can be considered, including solutions to control the traffic path so that it does not pass through the malicious ISP, and solutions to prevent traffic from being dropped by the malicious ISP by concealing the traffic identity.

The first class of solutions to the Internet access denial problem depends on preventing the traffic from being sent through the malicious TSP. Although BGP provides reachability information that includes the AS-path, it does not allow a network to control the actual routing path of its traffic. A network can only select which neighbor Autonomous Systems will route its packets, but does not know how that neighboring AS is going to handle them.

Controlling the outgoing and incoming traffic requires modifications or adjustments of the routing protocols. Source Routing, which allows the traffic originator to specify the path its traffic will travel through, is a solution to control the outgoing traffic so that it avoids the malicious ISP. However, the existing Internet protocols do not implement this type of routing. Modification of BGP is needed at all routers in the Internet to achieve this type of traffic control.

So-called “BGP Tuning” has also been studied, in which incoming traffic is controlled by using a techniques to influence the path selection process of remote Autonomous Systems. Three techniques have been studied, including AS-path pre-pending, where the length of the advertised AS-Paths is reduced to present them as a shorter path; prefix splitting, where the advertised IP prefix is segregated into a set of smaller IP prefixes to lead remote routers into selecting it as the longest prefix match; and the use of community, where remote cooperating routers use the community field in the BGP advertisements to identify the preferred paths.

“Virtual peering” is a further technique to control incoming traffic by using multi-hop BGP sessions. Remote Autonomous Systems establish virtual peering tunnels to control the traffic destined to the local AS. This solution, however, is not scalable as it requires all remote Autonomous Systems to implement virtual peering and establish tunnels for all communications. “Virtual transit” is a modification of virtual peering. The difference is that remote Autonomous Systems advertise the virtual-peering tunnel reachability information to their neighbor Autonomous Systems, allowing them to use the same established tunnel to transmit traffic to the local AS. Virtual transit has better scalability than virtual peering, as only a portion of Internet Autonomous Systems need to implement it.

The other class of Internet access denial solutions is based on hiding traffic identity from the malicious ISP so that it does not identify the traffic's origin or destination. These techniques use IP addresses that are different from the blocked ones. Therefore, the malicious ISP will be misled into routing the traffic without filtering it. One solution is to change the IP addresses of the victim network to different ones. The victim network can just register a new IP block and use it instead of its current one. This, however, only provides a temporary solution, as the malicious ISP can easily detect the new IP block and will simply block it again. Thus, this solution is not robust.

Network-layer encapsulation and tunnels are other methods of hiding the identity. Traffic is carried through a tunnel created between the two tunnel endpoints. First, packets are routed as usual until they reach the first tunnel endpoint. At the first tunnel endpoint, each packet is optionally encrypted and encapsulated as payload into another packet, and then sent to the other tunnel endpoint. The intermediate routers will only see the two tunnel ends as the source and destination addresses. Packets are then decapsulated at the other endpoint of the tunnel, and sent to their destination.

There are many tunneling protocols, such as IP-in-IP, Internet Protocol Security (IPSec), and Generic Routing Encapsulation (GRE). Additionally, anonymous routing protocols, such as Onion Routing, Cashmere, Crowds, and Hordes, provide means to hide the content of the packet, as well as the identities of the source and destination, from the routers that carry the traffic. However, implementing tunneling as a solution to bypass Internet access denial requires at least two cooperating networks as the endpoints of the tunnel. One of them should be located before the malicious network in the route path, and the other is located after it so that the tunnel is established through the malicious ISP. Although this solution is highly reliable once deployed, it does not work if no cooperating networks are found before and after the malicious ISP, such as in the case of “stub” malicious networks. It also does not work when the destination host is within the malicious network. Moreover, the use of anonymous routing protocols as a solution for Internet access denial results in very high performance degradation.

Network Address Translation (NAT) is a technique that allows a large number of hosts to use a small set of IP addresses to communicate with other hosts on the Internet. A NAT router separates the network into two sub-networks, a private network where the hosts are given private IP addresses, and the public network where the NAT router is connected to the Internet using its public IP address.

NAT can be used as an identity hiding technique by using a set of non-blocked IP addresses as the NAT's external IP addresses. All traffic will then use these non-blocked IP addresses when it is sent through the Internet. It would be desirable to be able to use NAT as an identity-hiding technique at the gateway-level of the victim network.

NAT was first proposed as a temporary solution for the IPv4 address exhaustion problem. As noted above, a typical NAT network consists of both a private network and the external public network through which the NAT router is connected using a public IP address. The NAT router and the private network behind it appear to the Internet as a single host with a single public IP address. Together with its main purpose of extending the IP address space, NAT can also provides a level of security for the private network by hiding its internal addressing structure and topology.

Thus, a network address translation-based method of bypassing Internet access denial solving the aforementioned problems is desired.

### SUMMARY OF THE INVENTION

The present invention relates to a network address translation (NAT)-based method of bypassing Internet access denial, in which NAT is used as an identity-hiding technique to bypass Internet access denial. The victim network uses NAT routers as a gateway to connect to neighboring networks, and uses a set of non-blocked Internet protocol (IP) addresses as the NAT routers' external public IP addresses. These addresses are not part of the IP ranges registered to the victim network. Rather, they are obtained from a neighboring network. The outgoing packets, therefore, will not be blocked by the malicious ISP, as they will not be recognized as part of the victim network.

Implementing the NAT-based method requires setting the gateway routers to use NAT to translate all traffic into the non-blocked public IP addresses. Once NAT is enabled and configured properly, clients within the victim network can send requests and receive responses. Even if traffic passes through the malicious ISP, it will not be recognized as traffic that belongs to victim networks, and the malicious ISP will route it normally through its network.

Although entities in the private network behind NAT are recommended to have IP addresses from the reserved private address blocks, they can still work with different IP address blocks if the NAT routers are configured properly. Thus, for the NAT-based method for bypassing Internet access denial, entities within the victim network, including hosts and routers, do not need any modifications to adapt to this method. The only modification needed is at the gateway routers. NAT can be set in the existing gateway routers, or dedicated NAT routers can be used as a layer between the private network and the gateway routers.

Hosts and routers in a conventional NAT system are assigned private IP addresses from the reserved private IP blocks. However, in the present method, the existing IP addressing is maintained without changes. NAT routers are then set such that they recognize the internal IP address blocks as private addresses, and the translation is performed between the internal IP blocks and the external public IP addresses.

Maintaining the same IP addresses allows the NAT-based method to be transparent to the clients within the victim network, as they do not have to make any changes in their networks. Further, local Domain Name System (DNS) servers do not have to update their records with private IP addresses, since no changes are made internally. Additionally, keeping the same addresses prevents addressing conflicts in case there are existing NAT networks within the victim network.

The method is scalable and has been found to have minimal performance impact on the network, Although NAT introduces some connectivity limitations, these are overcome by using application-layer routing for server reachability behind NAT, and NAT traversal techniques for peer-to-peer (P2P) applications.

In operation, a private network is established between at least one local server and an internal DNS server. The at least one local server and the internal DNS server are linked to a web switch. At least one DNS record associated with the at least one local server is stored in a public DNS server. When a remote client makes at least one hypertext transfer protocol (HTTP) request, the at least one HTTP request is forwarded from the remote client to the web switch through a network address translation router. The at least one DNS record stored in the public DNS server is associated with a public Internet protocol (IP) address of the network address translation router.

A transmission control protocol (TCP) connection is then initiated between the remote client and the web switch. The at least one HTTP request is then forwarded from the web switch to the at least one server. A Host header is read from the at least one HTTP request following the step of initiating the TCP connection between the remote client and the web switch, and this Host header is resolved to an IP address associated with the at least one server by the internal DNS server.

These and other features of the present invention will become readily apparent upon further review of the following specification and drawings.

### BRIEF DESCRIPTION OF THE DRAWINGS

FIG. 1 is a block diagram illustrating a network environment for implementation of a network address translation-based method of bypassing Internet access denial according to the present invention.

FIG. 2 is a block diagram illustrating the network environment of FIG. 1 extended by using load balancing for larger scale network architectures.

FIG. 3 is a block diagram illustrating a simulated network environment for measuring the effect of the network address translation-based method of bypassing Internet access denial on network performance according to the present invention.

FIG. 4A is a graph comparing end-to-end delays with NAT delay for a simulated low UDP traffic network.

FIG. 4B is a graph comparing end-to-end delays with NAT delay for a simulated low TCP traffic network.

FIG. 4C is a graph comparing end-to-end delays with NAT delay for a simulated medium UDP traffic network.

FIG. 4D is a graph comparing end-to-end delays with NAT delay for a simulated medium TCP traffic network.

FIG. 4E is a graph comparing end-to-end delays with NAT delay for a simulated high UDP traffic network.

FIG. 4F is a graph comparing end-to-end delays with NAT delay for a simulated high TCP traffic network.

FIG. 5A is a bar graph showing relative increase of end-to-end delay for low, medium and high UDP traffic as a function of NAT delay.

FIG. 5B is a bar graph showing relative increase of end-to-end delay for low, medium and high TCP traffic as a function of NAT delay.

FIG. 6A is a graph comparing throughput of high UDP traffic against NAT delay.

FIG. 6B is a graph comparing throughput of high TCP traffic against NAT delay.

FIG. 7 is a bar graph showing relative decrease of throughput for UDP and TCP traffic as a function of NAT delay.

FIG. 8 is a block diagram illustrating a network environment for implementation of an alternative embodiment of a network address translation-based method of bypassing Internet access denial according to the present invention.

FIG. 9 is a block diagram illustrating a load-balancing technique implemented in the network architecture of FIG. 8.

FIG. 10 is a block diagram illustrating a DNS-based technique implemented in the network architecture of FIG. 8

FIG. 11 is a block diagram illustrating a simulated network environment for measuring the effect of the alternative embodiment of a network address translation-based method of bypassing Internet access denial of FIG. 8 on network performance.

FIG. 12A is a graph comparing end-to-end delay against web switch delay for the alternative embodiment of FIG. 8 for a low web traffic simulation.

FIG. 12B is a graph comparing end-to-end delay against web switch delay for the alternative embodiment of FIG. 8 for a high web traffic simulation

FIG. 13 is a bar graph illustrating relative increase in end-to-end delay for web traffic for the embodiment of FIG. 8.

FIG. 14 is a graph comparing throughput for high web traffic against web switch delay for the embodiment of FIG. 8.

FIG. 15 is a bar graph illustrating relative decrease of throughput for web traffic for the embodiment of FIG. 8.

Similar reference characters denote corresponding features consistently throughout the attached drawings.

### DETAILED DESCRIPTION OF THE PREFERRED EMBODIMENTS

The present invention is directed towards a network address translation (NAT)-based method of bypassing Internet access denial in which NAT is used as an identity-hiding technique to bypass Internet access denial. The victim network uses NAT routers as a gateway to connect to neighboring networks, and uses a set of non-blocked Internet protocol (IP) addresses as the NAT routers' external public IP addresses. These addresses are not part of the IP ranges registered to the victim network. Rather, they are obtained from a neighboring network. The outgoing packets, therefore, will not be blocked by the malicious ISP, as they will not be recognized as part of the victim network.

Implementing the NAT-based method requires setting the gateway routers to use NAT to translate all traffic into the non-blocked public IP addresses. Once NAT is enabled and configured properly, clients within the victim network can send requests and receive responses. Even if traffic passes through the malicious ISP, it will not be recognized as traffic that belongs to victim networks, and the malicious ISP will route it normally through its network.

Although entities in the private network behind NAT are recommended to have IP addresses from the reserved private address blocks, they can still work with different IP address blocks if the NAT routers are configured properly. Thus, for the NAT-based method for bypassing Internet access denial, entities within the victim network, including hosts and routers, do not need any modifications to adapt to this method. The only modification needed is at the gateway routers. NAT can be set in the existing gateway routers, or dedicated NAT routers can be used as a layer between the private network and the gateway routers.

Hosts and routers in a conventional NAT system are assigned private IP addresses from the reserved private IP blocks. However, in the present method, the existing IP addressing is maintained without changes. NAT routers are then set such that they recognize the internal IP address blocks as private addresses, and the translation is performed between the internal IP blocks and the external public IP addresses.

Maintaining the same IP addresses allows the NAT-based method to be transparent to the clients within the victim network, as they do not have to make any changes in their networks. Further, local Domain Name System (DNS) servers do not have to update their records with private IP addresses, since no changes are made internally. Additionally, keeping the same addresses prevents addressing conflicts in case there are existing NAT networks within the victim network.

Since the NAT-based method is meant to solve the Internet access denial problem, the victim network can range from a small LAN to an entire country or region. Thus, the present method is designed to be scalable to fit the size and requirements of the victim network. For a small network, a single NAT router with an external IP address is used. The NAT router is used to connect to the Internet, and all the traffic is translated into its public IP address. As the size of the private network increases, scalability issues start to appear.

The first issue is the limited number of possible port-mappings. NAT maps each session to a single external port number. The “tuple” of source IP:Port and destination IP:Port is used to map subsequent traffic to the same external port number. Transmission control protocol (TCP) and user datagram protocol (UDP) use 16-bit port numbers, providing 65,536 ports. Ports from 1 to 1023 are called the “well-known ports”, as they are reserved for specific applications by the Internet Assigned Numbers Authority (IANA), and they should not be used as source ports. Thus, a NAT router can map up to 64,512 sessions at the same time with a single external IP address.

If there are more connections coming from the private network to the router, it may not be able to serve them, since there are no more available ports. This issue is resolved by using a pool of public IP addresses instead of using a single public IP address. Adding public IP addresses increases the available ports exponentially, since every added address provides the complete port space to be used for mapping. FIG. 1 shows the extended network where the NAT router 12 uses an IP pool, 3.3.4.0/28 for example, which consists of 16 public IP addresses, from 3.3.4.0 to 3,3.4.15. The NAT router 12 connects a private network formed from sub-networks 14 to the Internet I.

Other NAT scalability issues to be considered include memory, bandwidth, and processing requirements. For each NAT mapping, an entry is added to the NAT table. Since a NAT router can map up to 64,512 sessions at the same time with a single IP address, that many NAT entries are expected to be in the NAT table. A NAT table entry requires about 160 bytes. Therefore, a fully utilized NAT table with 64,512 entries would require a little less than 10 megabytes of memory, which represents a small portion of the available memory in present routers. Thus, the growth of the NAT table is not an issue when a single public IP address is used. However, the use of pools of public IP addresses will significantly increase the required memory. For example, the NAT table resulting from the full mapping of a pool of 16 IP addresses would require 160 megabytes, which is considerably high. Therefore, router memory may become a limitation on the design. Moreover, the NAT router has a limited processor power so that it may not be able to handle that much traffic. Bandwidth and processor limitations also need to be considered.

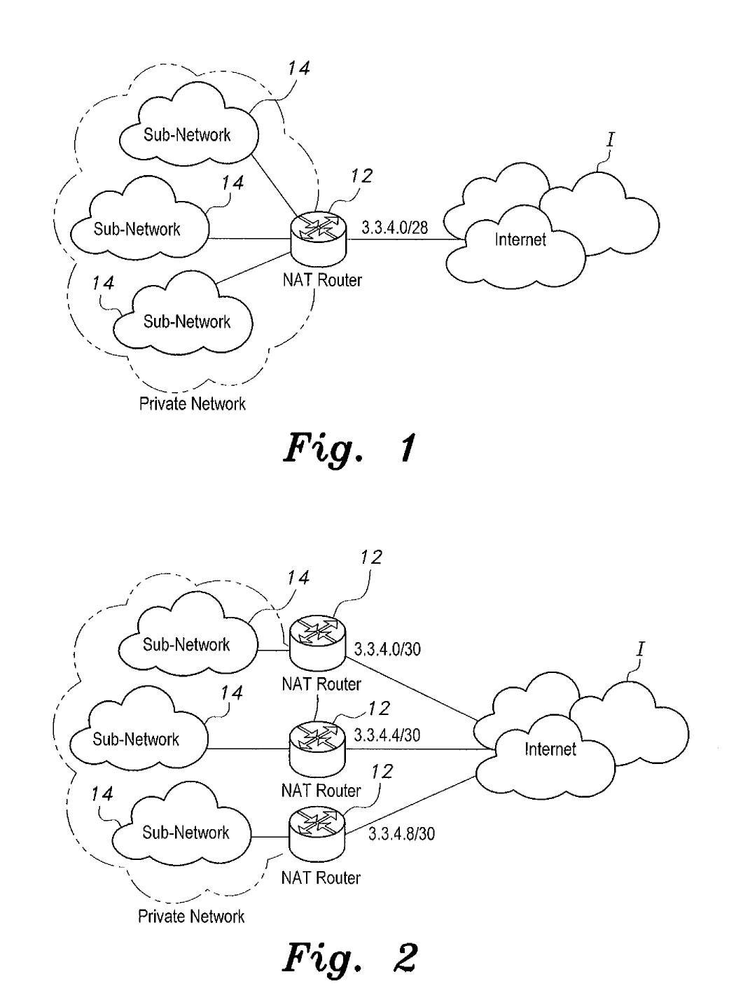

To resolve these issues, load balancing can be used by adding more NAT routers at the gateway level. Each NAT router handles a portion of the private network, and has its own pool of IP addresses, as shown in FIG. 2. This method provides large scalability of the solution, since more NAT routers can be added as needed. The partitioning of the internal network can be performed based on the physical topology. The private network is partitioned into a number of sub-networks 14, and each sub-network uses its own NAT router 12 to translate traffic. For example, if the NAT-based method is to be implemented on a country-wide level, the country's network can be partitioned by ISPs. Each ISP is then a sub-network 14 that is connected to the higher-tier ISP using one or more NAT routers 12.

Enabling NAT in a router introduces a computational overhead that theoretically affects performance. NAT performs a number of added operations on packets. For each packet, the NAT router changes the IP address of the source (or destination, for incoming packets), and replaces the source and destination ports. The router also performs NAT table lookup to find a matching entry, and if none is found, it adds a new entry. TCP packets have a packet-checksum in their TCP header, which also needs to be recomputed after the IP address and port translation. However, the extra delay added by enabling NAT is generally considered to be very small and negligible because routers are designed to minimize the NAT computational overhead. NAT may even have zero impact on performance, as some routers are designed using session-based architecture, where the router keeps track of complete connection sessions and is aware of the packet's transport-layer information. Nevertheless, in the following, the effect of NAT on network performance is evaluated by first modeling the NAT processing overhead, then describing the simulation setup, and finally presenting the simulation results.

Most popular network simulators do not consider NAT processing delay in their simulations. In order to correctly evaluate the performance of NAT, a correct delay model of NAT needs to be implemented in the simulator. The overhead of TCP has been studied. In this study, the computational overhead was measured at the transport layer, such as TCP checksum computation, and memory read and write accesses. It was concluded that the TCP overhead is very small, and it is not the source of processing overhead. The overall overhead per packet does not exceed a fraction of a millisecond.

Network processors have developed significantly over the last two decades, and the measured TCP overhead would be even smaller in the present network environment. NAT computational overhead is somewhat similar to the TCP overhead, as both are in the transport-layer, and they have similar computations, such as the checksum calculation. Thus, it is possible to approximate the NAT delay to the measured TCP overhead.

The network processing delay that packets experience has also been studied. It has been estimated estimated that on a 1 Gbps network, the processing delay of complex packet modifications, including NAT, firewall, and IPSec encryption, is 1,000 μs. This is based upon a model of a simplified network processor that is used to measure the end-to-end delay that a single packet experiences. However, the effect on the overall throughput was not considered, as routers are designed to improve performance by processing many packets in parallel using multi-core processors, and the processing overhead would have a significant effect only on the end-to-end delay of a single packet.

Although this study showed that processing delay is not very small, it can still be considered as negligible for the NAT-based method for bypassing Internet access denial. The reason is that the measured delay is much smaller than the Internet delay, which ranges from tens to hundreds of milliseconds. Further, the measured delays included not only NAT, but also more complex operations, such as encryption and firewall. Thus, the NAT delay is only a small portion of the measured processing delay. Moreover, routers process traffic with high-levels of parallelism and pipelining. This hides the processing delay for a flow of packets.

Therefore, the NAT processing delay is expected not to have any significant impact on the performance of the network, as long as the same network resources are available. Nevertheless, in order to evaluate the impact of implementing the present NAT-based method on the network, simulations were performed using an OPNET Modeler® network simulator, manufactured by OPNET® Technologies, Inc. of Bethesda, Md.

The simulations were used to compare the network performance before and after implementing the NAT-based method. The performance metrics used were end-to-end delay, traffic throughput, and packet drop rate. Different applications were tested under different traffic loads.

The range of NAT delay values simulated were between 10 μs and 250 μs. In reality, the range for real routers is between approximately 10 μs and approximately 50 μs. The remaining range (i.e., from 50 μs to 250 μs) does not reflect the real routers' performance. It was simulated only to see the effect of high processing delay on performance.

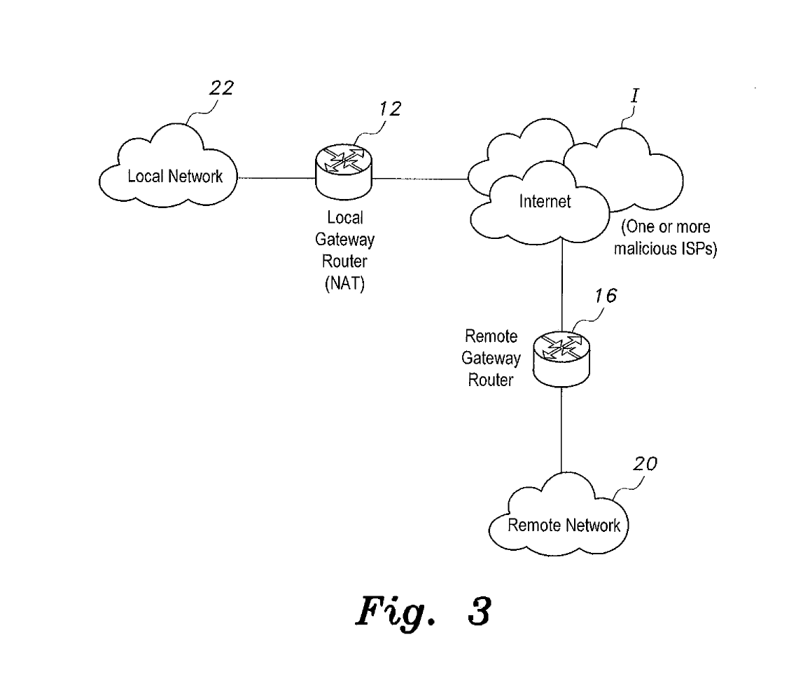

The simulated network is illustrated in FIG. 3. The simulated network consists of two sub-networks, a local network 22 and a remote network 20. Each sub-network consists of a Local Area Network (LAN) and a gateway router. NAT is enabled in the local network's gateway router 12, but not on the remote network's gateway router 16. An IP cloud, representing the Internet I, connects the two gateway routers 12, 16. The local and remote networks are set to 100 Mbps Fast Ethernet networks. Each network has ten connected hosts that serve as clients and servers for each application. The gateway routers 12, 16 are based on the generic router model in the OPNET Modeler® network simulation. The simulation supports many protocols, including BGP and NAT. Both routers 12, 16 are connected to the central Internet cloud I using DS-1 links, providing a data rate of 1.544 Mbps.

Two applications are simulated, including file transfer protocol (FTP), which runs over TCP, and video conferencing, which runs over UDP. Each application is simulated under three traffic scenarios: low, medium, and high traffic. The low traffic scenario uses 25% of the available link's bandwidth, which is about 380 kbps. The medium traffic uses 50% of the bandwidth (about 770 kbps), and the high traffic utilizes 75% of the bandwidth (about 1,200 kbps). These scenarios were selected to evaluate the performance of NAT under different traffic loads. Each simulation was run five times, and the average of the five results was taken. Performance was evaluated for the following metrics: end-to-end delay, traffic throughput, and the packet drop rate.

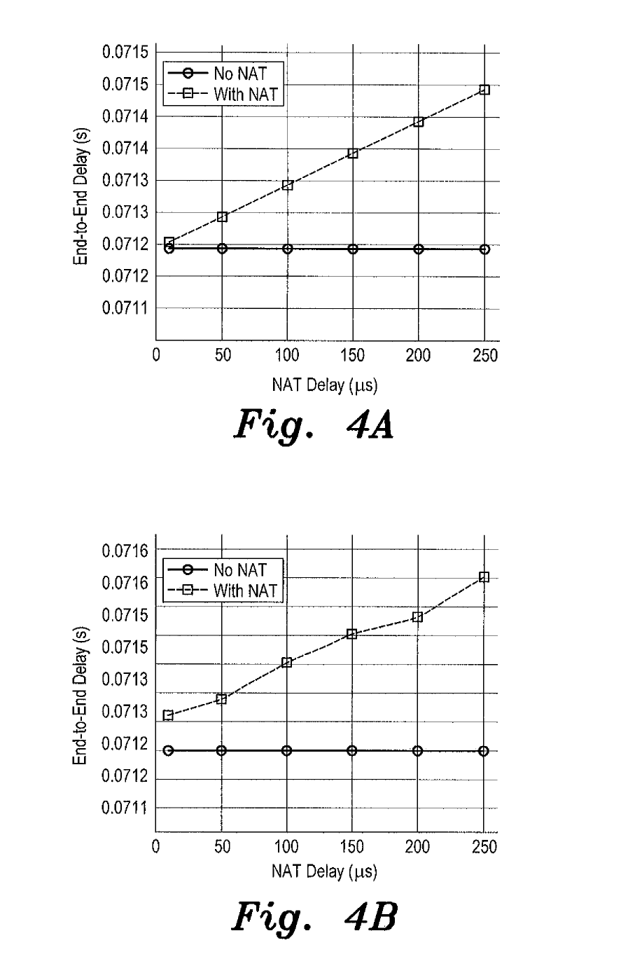

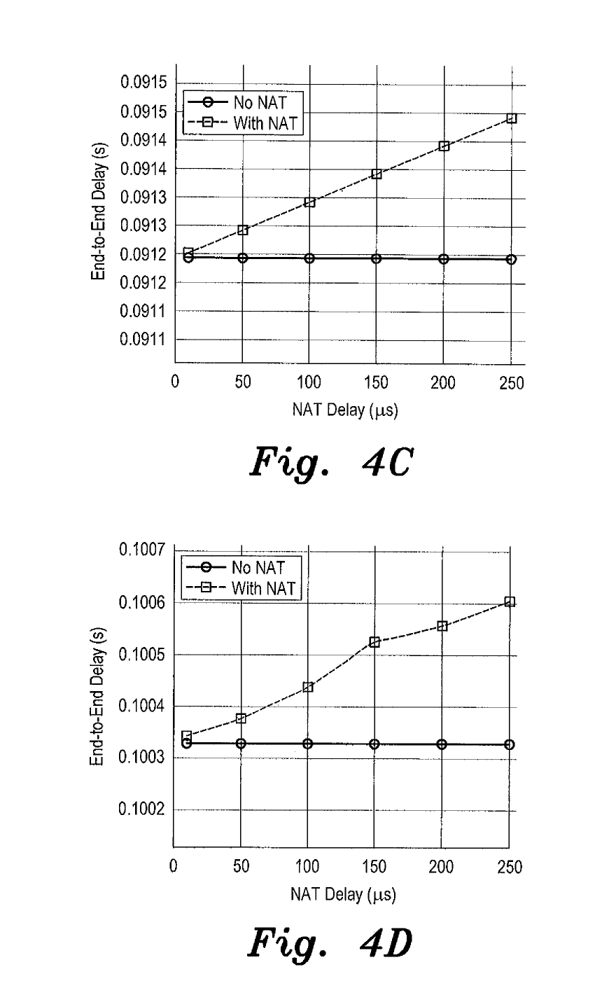

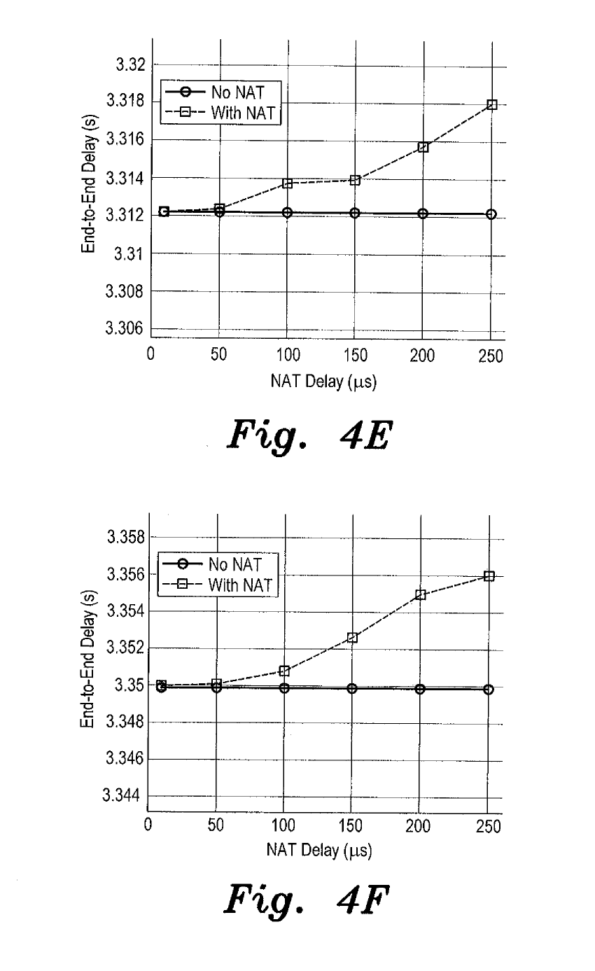

Each simulation measures the end-to-end delay, which refers to the amount of time that a packet takes to travel from the client to the server, and includes the transmission times, the queuing delays, and the added NAT delay. FIGS. 4A-4F show the effect of NAT delay on the total end-to-end delay for both UDP and TCP traffic. FIG. 4A illustrates end-to-end delay for low UDP traffic (25%), both with and without NAT vs. the simulated NAT delay. Similarly, FIG. 4B illustrates end-to-end delay for low TCP traffic (25%), both with and without NAT vs. the simulated NAT delay, Similarly, FIGS. 4C and 4D illustrate end-to-end delay for medium (50%) UDP and TCP traffic, respectively, and FIGS. 4E and 4F illustrate the end-to-end delay for high (75%) UDP and TCP traffic, respectively. When NAT is not enabled, the NAT delay is not taken into consideration, and the end-to-end delay is constant. However, when NAT is enabled, the delay that packets suffer to reach the destination increases linearly.

The added NAT delay is suffered by every packet that passes through the router. Since OPNET does not reflect the parallelism and pipelining that actual routers have, the simulated router is modeled as a GID/1 queuing system. Thus, the delay suffered by an arriving packet is N×τ, where N is the number of packets in the system, and τ is the processing time. An added NAT delay of Δτ will result in increasing the processing time to N×(τ+Δτ)=Nτ+NΔτ. Thus, the increase of Δτ causes a linear increase of the processing time by NΔτ.

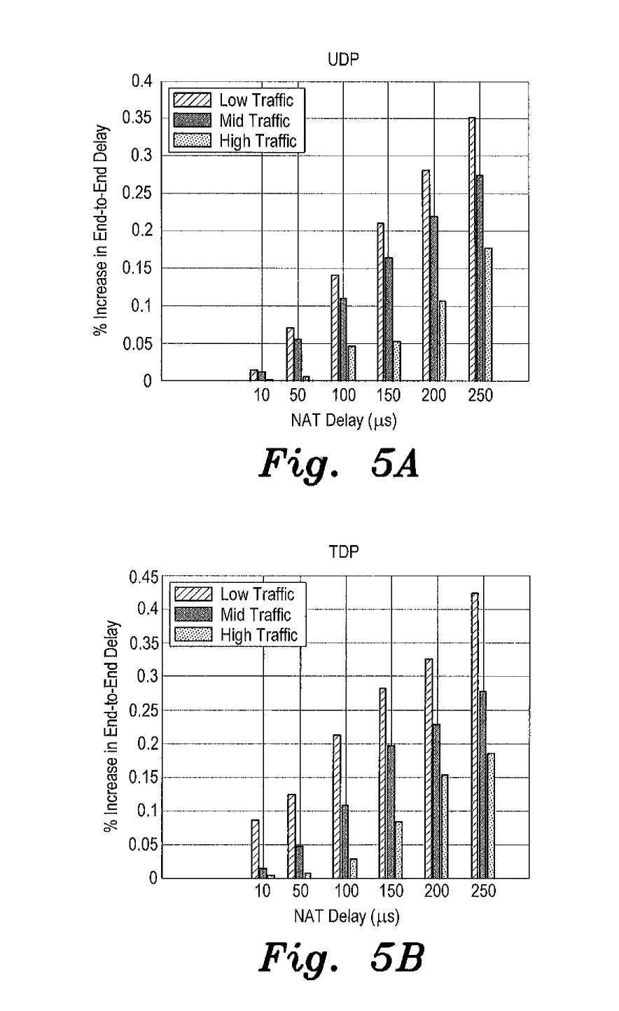

The relative increase of the end-to-end delay for UDP and TCP traffic is shown in FIGS. 5A and 5B, respectively. The relative increase is computed as (Delay_{NAT}−Delay_{NoNAT}/Delay_{NoNAT}. It should be noted that for small NAT delays, specifically below 100 the effect of NAT does not exceed 0.1% of the total end-to-end delay. Larger values of the NAT delay cause a relatively higher increase in the end-to-end delay. However, the maximum delay in the highest NAT delay still does not exceed 0.45% of the total delay. It should further be noted that the relative effect of NAT delay is lower when the traffic is high. This is because higher traffic results in a higher queuing delay, which eventually becomes more significant than the NAT delay. Thus, the relative effect of NAT delay is lower.

From the above, it can be concluded that NAT does not have any significant impact on the end-to-end delay. The maximum increase of the end-to-end delay does not exceed 0.5% in the worst case, when the NAT delay is higher than 200 μs, which is an extremely unrealistic scenario. However, for the reasonable range of NAT delay, which is between 10 μs and 50 μs, NAT results in only a very small and negligible effect on the end-to-end delay.

Throughput is another performance measure that was evaluated in order to study the impact of NAT on the amount of transmitted and received traffic. Throughput is measured as the amount of application traffic sent and received by the hosts per second. The simulation was set to measure the throughput at the client side. The same simulation setup was used, in which the three scenarios of 25%, 50% and 75% traffic were simulated, and the NAT delay was varied between 10 μs and 250 μs.

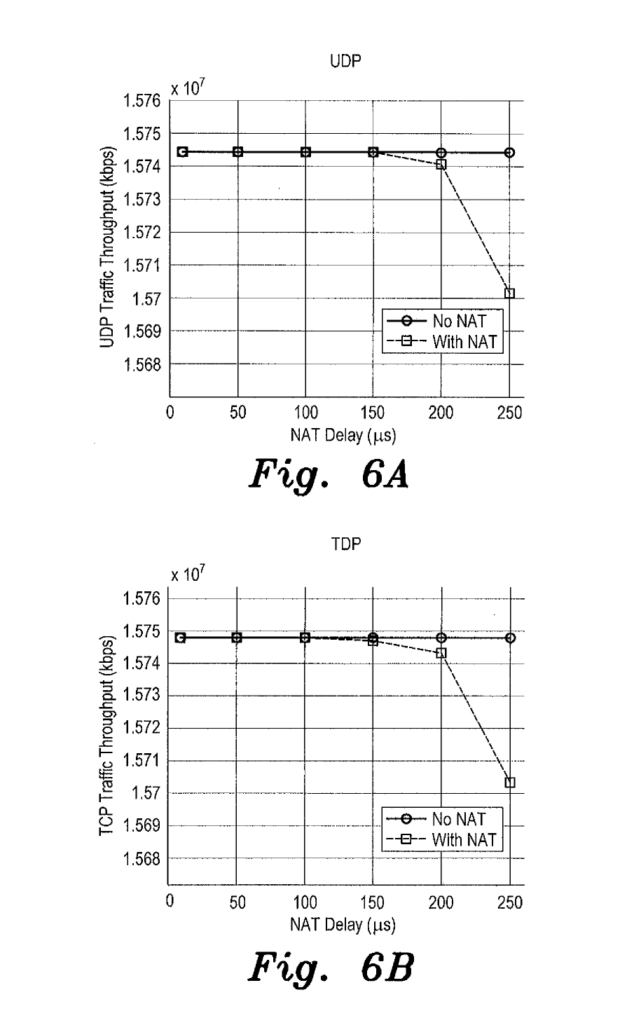

For the cases of low and medium traffic, NAT was not found to have any effect on the throughput. Both scenarios (with and without NAT) produced exactly the same measured throughput. In the case of high traffic, NAT only started to affect the throughput when the NAT delay was very high; i.e., more than 150 μs. FIGS. 6A and 6B show the throughput for UDP and TCP traffic, respectively, for the high load (75%) scenario. The degradation of throughput is due to the high NAT delay, which slows down the processing of packets, and further causes the router queue to be filled with waiting packets.

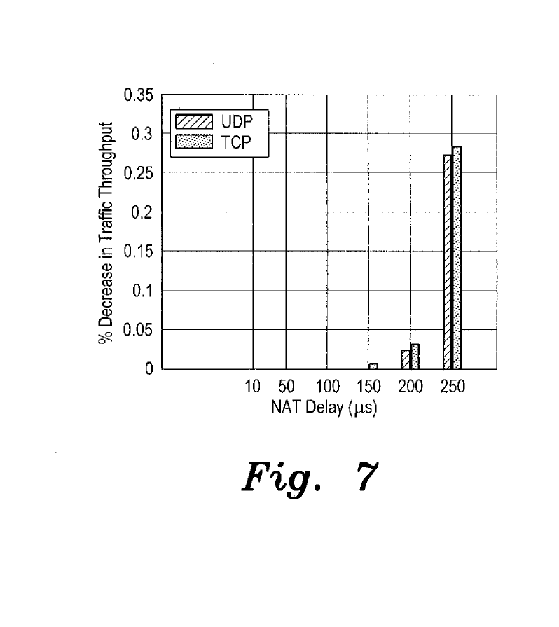

The relative decrease of throughput, which is computed as (Throughput_{NoNAT}−Throughput_{NAT})/Throughput_{NoNAT}, is shown in FIG. 7. It should be noted that the degradation of throughput starts earlier in TCP traffic, as a NAT delay of 150 μs causes a small decrease in the throughput. The maximum relative decrease is less than 0.3% of the total throughput, which is insignificant. Nevertheless, in the realistic NAT delay range, the throughput is not affected at all. Thus, it is concluded that NAT does not affect the network throughput except at the extreme cases of high NAT delay, and even in such cases, the performance degradation is negligibly small.

With regard to the drop rate, which measures the average number of packets that are discarded per second due to a network congestion, the simulation results showed no increase in the drop rate. Thus, NAT does not have any significant impact on the performance of the network. The performance degradation that was measured using simulations occurs only when the NAT delay is set to a very large or extreme value. Therefore, deploying NAT as a solution for Internet access denial will operate transparently without any performance drawbacks. As noted above, the method can easily be scaled for larger networks as well.

As shown above, the present NAT-based method does not have any significant impact on the overall network performance. However, there are known connectivity limitations caused by NAT that should be addressed. Since the private network behind a NAT router appears as a single entity to other public hosts, incoming connections will use the public IP address of the NAT router as their destination address. However, the NAT router will not be able to route the incoming connections because there is no information on which a private host should receive this connection. This issue causes two types of limitations, peer-to-peer (P2P) application connectivity and server reachability behind NAT.

One of the drawbacks of NAT is the limitation of end-to-end connectivity between hosts. This limitation prevents P2P applications from working properly. The reason for this is that a peer in a P2P network acts as both a client and a server. NAT only allows connections to be initiated from within the private network, and those destined to a host in the public Internet. Incoming connections are not received by the peer because there is no way of addressing the peer, as the private network behind NAT is seen by outsiders as a single host. This does work for some applications where the connections are initiated by the peers behind NAT. However, if the remote peer is also behind NAT, the problem gets more complicated.

Numerous NAT traversal techniques and protocols have been explored. Some of these techniques involve utilizing the NAT router to map ports or tunnel traffic, while other techniques are more transparent and exploit the behavior of NAT in order to deliver traffic. Control-based NAT traversal techniques, such as Application-Level Gateway (ALG), Internet Gateway Device Protocol (IGD), and Middlebox Communication (MIDCOM), provide ways for the client to create an external address mapping on the NAT router. This allows the client to receive incoming connections that are destined for that address mapping. Behavior-based techniques, on the other hand, do not use the NAT router as a way of receiving connections, but accomplish connectivity by coordinating with the other peer. Examples of these techniques are Hole-punching and Relaying. These are used in many NAT traversal protocols, such as Traversal Using Relays around NAT (TURN) and Interactive Connectivity Establishment (ICE).

Deploying NAT as an Internet access denial solution may require P2P applications to use one or more NAT traversal techniques to be able to function correctly. The modification of these applications may take place on the local clients, the NAT routers, and/or the remote clients on the Internet, depending on the NAT traversal protocol that is used.

Servers on the Internet are addressable using a tuple of their IP address and poll. Thus, any client can reach a server using this tuple. Normally, servers have public IP addresses, and thus, they are directly reachable. However, introducing NAT changes the IP address of the server to a private IP address, and the server is only seen using the NAT's public IP address. Further, running multiple servers for the same service, such as HTTP servers, behind a single NAT router means that these servers are sharing the public IP address used by the NAT router. Therefore, they are all addressable using the same tuple, i.e., the NAT public IP address and the service port.

Running multiple servers with a single public IP address has been used in many web-server scalability designs. Web clusters and distributed web servers are the most common examples of such designs. Some approaches are used to run a single website on multiple servers with a single IP address to achieve load balancing, while other approaches are used to run multiple websites on a single server with one IP address to achieve higher utilization of hardware.

A very common technique to run multiple websites over a single server with a single IP address is Virtual Hosting, which is implemented in most HTTP server applications. This technique uses layer-7 information, specifically the Host part of the HTTP request headers, to specify which site is the correct destination for that request. However, the virtual hosting technique does not provide a way for accessing multiple servers, each with a different private IP address, when the servers are placed behind a NAT router with a single public IP address.

Web clustering is another technique that is used to allow a single website to run on multiple servers (or cluster nodes) with a single public IP address for the purpose of scalability. The distribution of requests over multiple servers is performed transparently from the client using an intermediate router. There are two types of routing mechanism for web clusters, layer-4 routing and layer-7 routing.

In layer-4 routing, the router is content-blind; i.e., it is not aware of the application layer information, such as the requested page. Therefore, every web cluster node has the complete content of the website. The router selects a node to serve each incoming connection, and binds the selected node with the client address so that subsequent information are sent to and received from the same node.

Layer-7 routing, however, is content-aware. Thus, it is possible to distribute the content over different server nodes, where each node can serve a specific type of content. Requests in layer-7 routing are first accepted by the router, which reads the application layer information. Such a router is also called a “web switch”. The web switch accepts the TCP connection, receives the HTTP request, and then decides which server node should handle this request based on some dispatching policy. The request is then handed over to the selected node.

As noted above, when there are many web servers behind the NAT router, then all of them share the same address; i.e., the NAT public IP address, and they also share the same TCP port (the standard HTTP port 80). Thus, when the NAT router receives a request for a web server behind it, the NAT router is unable to identify the correct destination for that request, as there is no network or transport layer information that tells the NAT router which server is the destination.

The problem is that neither network layer information nor transport layer information help in identifying the correct destination of the HTTP request. However, application layer information, namely the HTTP Host header, can be used to map a request to the proper destination website. Thus, the present method uses a similar approach to the web clustering techniques that use layer-7 routing, but on a server-level mapping, rather than a website-level mapping.

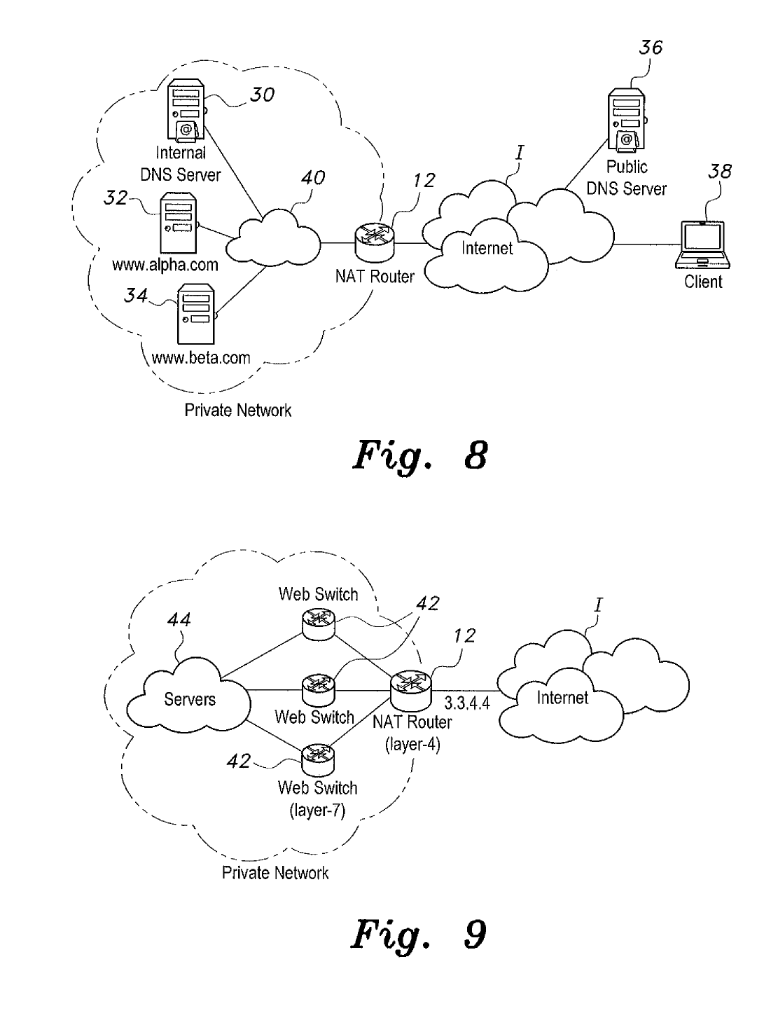

FIG. 8 shows a network overview for the multi-server implementation of the present method. The network in FIG. 8 includes the NAT router 12 connected to the Internet I with a public IP address, a number of web servers 32, 34 in the NAT's private network, and a client 38 that is connected to the Internet and is attempting to access one of the web servers 32, 34 behind the NAT router 12. There are also both public and internal DNS servers 36, 30, respectively. A web switch 40 is used to accept the HTTP request. It can either replace the NAT router 12, acting as both a NAT router and a web switch, or the NAT router 12 can just forward all traffic destined to port 80 to the web switch 40 that is placed in the private network. The DNS records of the web servers 32, 34 are stored in the public DNS server 36, and they all point to the NAT's public IP address. The clients will use the public DNS servers 36 to resolve the domain names of the HTTP servers to their IP addresses (i.e., NAT's public IP address).

After resolving the server's name and getting the IP address, the client 38 initiates a TCP connection to the HTTP port 80 of that IP address. The web switch 40 accepts the connection and receives the HTTP request. Then, the web switch 40 reads the Host header from the received request, and uses the internal DNS servers 30 to resolve the host name into an IP address. This IP address, corresponding to the private address of the correct destination server of the request, is directly accessible by the web switch 40, since the web switch 40 is part of the private network.

After the web switch 40 has identified the correct web server for that HTTP request, it forwards the HTTP request to that server. Forwarding is performed using transport layer forwarding of traffic, which utilizes a table for mapping that is similar to the NAT table. This table is referred to as a “web-switch table”.

Once the web switch 40 receives the HTTP request and identifies the intended web server, an entry is added to the web-switch table that maps the client's address tuple (client's IP address and source port) to the server's address tuple (server's private IP address and destination port, which is port 80 in this example). This table entry is used to forward subsequent traffic between the client 38 and the web server until the end of the HTTP session. Similar to the usual NAT tables, the entries are deleted after some timeout period, or at the termination of the TCP connection using a packet with the FIN flag. Packets are address-translated into local IP addresses, similar to the way NAT translates them, then the translated packets are sent to the proper server. It should be noted that only the first packet of each HTTP session is examined at the application layer. All subsequent packets are address-translated and forwarded at the transport layer, in a similar way to NAT forwarding.

The advantage of using this method is that no modifications are made to the servers 32, 34 within the private network placed behind the NAT router 12. Another advantage of the method is that it is transparent to the clients 38. This method can be applied to a NAT network of any size. There is no limit on the number of web servers behind NAT, as long as other resources, such as DNS servers and bandwidth, are available. The web switch 40 is considered the performance bottleneck of the method. Thus, solution scalability is based on how the web switch 40 scales.

One approach to such scalability is to use load balancing. In FIG. 9, incoming requests are distributed equally over a number of web switches 42 that are interconnected with the gateway NAT router 12. When a request is received by the NAT router 12, it first checks its NAT table to see if this request has already been mapped to one of the web switches 42. If no mapping is found, the NAT router 12 selects one of the web switches 42 to handle this request, adds an entry to its NAT table to map the connection with that web switch, and then forwards the packets to the selected web switch 42. It should be noted that the processing done at this level is only layer-4 processing, and that no application layer data are processed yet. The selected web switch 42 accepts the client's request, and finds the correct server 44 using layer-7 information. It then forwards the request to the intended server 44 after adding an entry to its web-switch table.

The objective of the NAT table at the NAT router 12 is to map web switches 42 to incoming packets. Subsequent packets from the same client destined to the same server should all be processed by the same web switch. Thus, the NAT table is used to keep track of this mapping. The web-switch table on a web switch is used to map packets of the same session together. Once the server is located using layer-7 information, all subsequent packets are forwarded directly to the web server, and all responses are forwarded directly to the client.

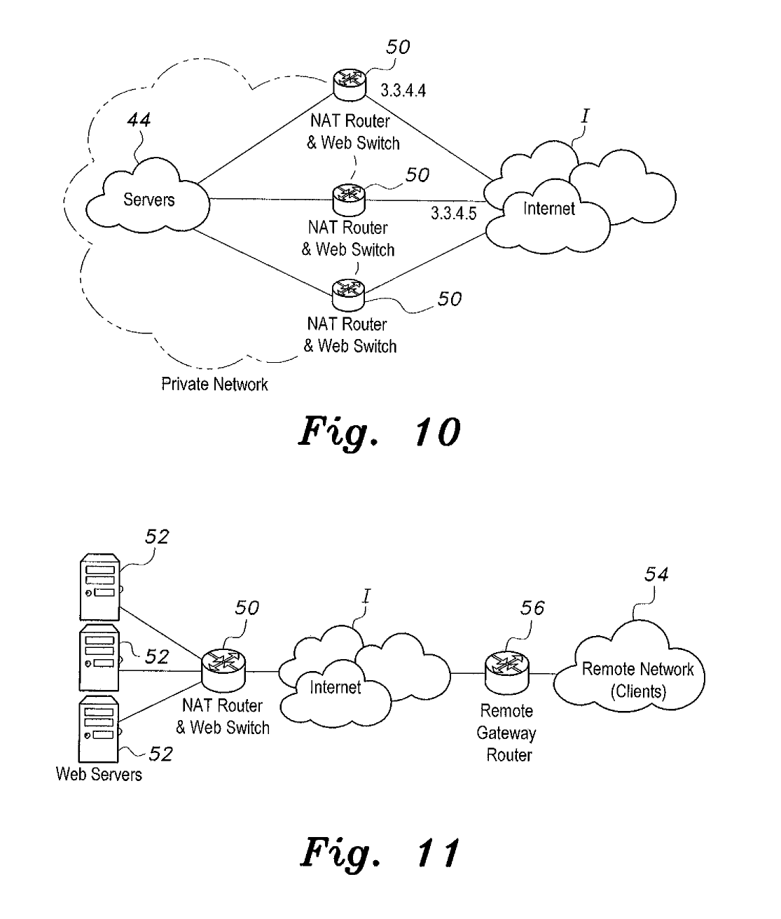

The other scalability approach of load-balancing the incoming traffic is to utilize round-robin DNS. Entries in the DNS can have more than one IP address. FIG. 10 illustrates the topology for implementing such an approach, in which the NAT routers and web switches are combined into single integrated units 50, as described above. Thus, multiple public IP addresses can be associated with the public DNS entries corresponding to the private network servers 44. Hence, after accessing the public DNS to resolve the server name, the clients will use different IP addresses to connect to the same server. By placing a number of web switches 50 at the gateway level, each with a different public IP address, incoming traffic will be balanced over the different web switches 40.

It is possible to combine both approaches to maximize scalability. A number of NAT routers can be used at the gateway level, each with a different public IP address. These IP addresses are all used in the public DNS for load balancing. Each NAT router is connected to a number of web switches that will process layer-7 information and forward the requests to the intended web server. This way, load balancing is performed at both gateway level and web switch level.

The above method adds extra overhead to the network, and therefore has some impact on the overall performance. Simulations using the OPNET Modeler® network simulator were used to evaluate the performance of the present method for the HTTP servers behind NAT. The objective of simulating the HTTP solution was to measure the impact of implementing the web server solution on the network performance. Two metrics were used for measurements, end-to-end delay between the clients and servers, and the throughput of the sent and received traffic.

The above method requires layer-7 processing of only the first packet, and subsequent packets are processed at layer-4. Thus, it can be assumed that the performance evaluation of NAT is a good approximation of the performance of a web switch, except for the layer-7 processing of only the first packet. As noted above, the NAT delay is considered insignificant. Thus, the performance impact of the present method may be affected by layer-7 processing of the first packet.

In order to measure the effect of layer-7 processing on the performance, the web switch delay is implemented in the OPNET Modeler® network simulator such that it adds an extra processing delay for the first packet of a request. Subsequent packets only suffer from the layer-4 NAT delay, which is smaller than the web switch delay. The implementation is performed such that when a NAT table lookup is added, the packet processing delay is increased by the web switch delay. This is because NAT table entries are only added for the first packet of every session, which is the same packet that will have layer-7 processing. The processing time of all subsequent packets and responses only suffers from a small extra NAT delay.

The network architecture of the simulated scenario is shown in FIG. 11. It consists of both a private network, formed from servers 52, and a remote network 54. Each network is connected to the Internet I through a gateway router. The private network gateway is a web switch 50 that has the implementation of NAT delay and web switch delay. The remote network 54 consists of a 100 Mbps Fast Ethernet LAN, with ten hosts that act as web clients, and a gateway router 56. The intermediate links connecting gateway routers 50, 56 to the Internet I are DS-1 links with 1.544 Mbps data rate.

The measurements are selected to compare the performance of using a normal router, where servers have public IP addresses, with the use of a web switch, where packets suffer added NAT and web switch delays. Because all packets that pass through the web switch are translated, NAT delay is added to the processing time. Based on the above, the selected simulation NAT delay is 50 μs.

As shown above, the degradation of performance caused by NAT is very similar for low and medium traffic. Thus, only two traffic loads have been simulated, low, where 25% of the DS-1 bandwidth is utilized (about 380 kbps), and high, where 75% of the DS-1 bandwidth is used (about 1,200 kbps).

Since the web switch delay is caused by the processing of layer-7 information, this delay is expected to be higher than the one caused by NAT for layer-4 processing. In the simulations, different scenarios were simulated with varying values of web switch delay. Based on the fact that more complex operations, such as firewall and IPSec encryption, have a processing delay that is less than 700 μs, a range between 100 μs and 400 μs was used as a web switch delay. This delay was only added to the first incoming packet of the session.

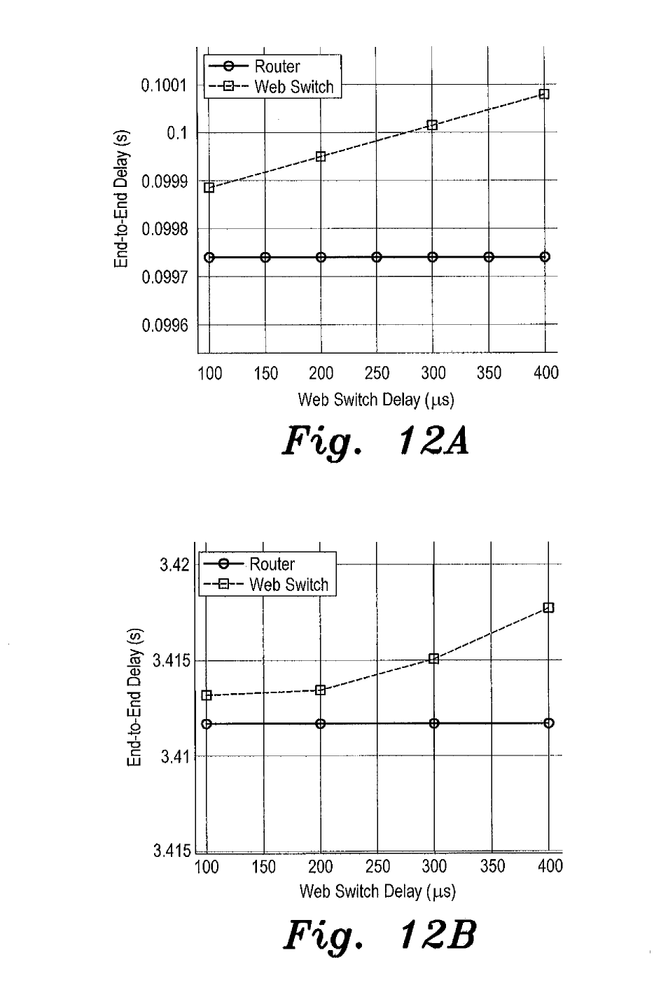

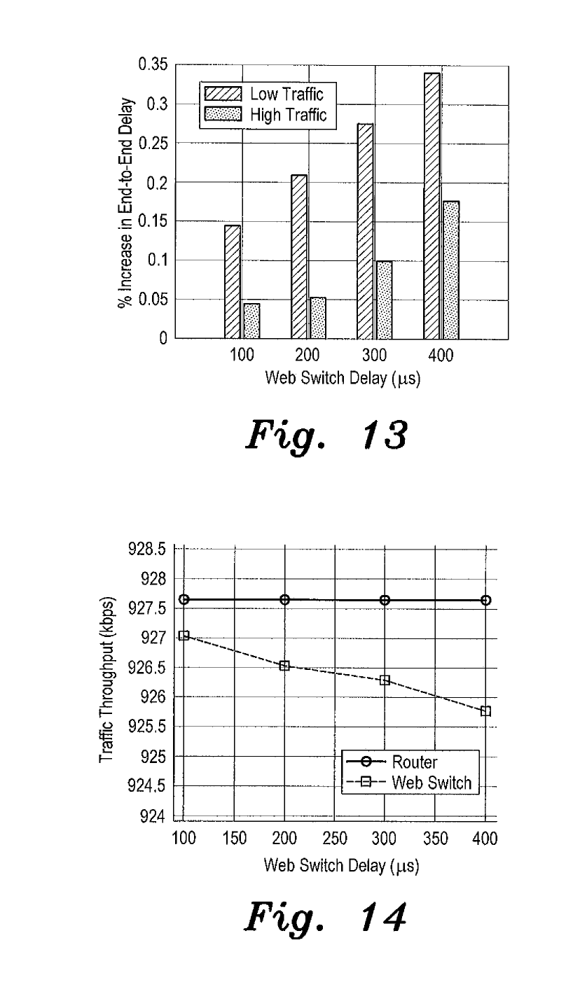

The simulation of the impact of the web switch on end-to-end delay is shown in FIG. 12A for a low web traffic load and in FIG. 12B for a high web traffic load. In FIGS. 12A and 12B, the solid line in refers to the end-to-end delay when both the NAT router and the web switch are not installed, and the dashed line refers to the end-to-end delay when both the NAT router and the web switch are installed. In FIG. 12A, it can be seen that a small increase is caused by the web switch, and the effect increases as the web switch delay is increased. About 150 μs of additional end-to-end delay (i.e., a total of 99.8 ms of end-to-end delay) is measured when the web switch delay is 100 μs, but the additional end-to-end delay increases to 350 μs (i.e., a total of 100 ms of end-to-end delay) for a web switch delay of 400 μs. There are two factors causing this increase of the end-to-end delay: First, all packets require extra processing time because of the added NAT delay. Second, the first packet of every HTTP session suffers an extra web switch processing delay. Similarly, in FIG. 12B, the end-to-end delay increases when a web switch is used because of the added web switch and NAT delays, which cause all packets to require extra processing time.

The relative increase in the end-to-end delay, computed as (Delay_{WebSwitch}−Delay_{Router})/Delay_{Router}, is shown in FIG. 13. Although the amount of increase in the end-to-end delay in the high traffic load scenario is higher than the amount of increase in the low traffic load scenario, the relative increase in the end-to-end delay in high traffic load scenario is smaller than the low traffic load scenario. The reason for this is that the processing delay for high traffic becomes less significant than the queuing delay. Thus, the relative increase in the end-to-end delay caused by NAT and web switch delay is smaller.

It should be further noted that the maximum increase in the end-to-end delay in the worst case does not exceed 0.35% of the total end-to-end delay. This increase does not have a significant effect on the performance. Thus, it can be concluded that the present HTTP server solution has a small, insignificant impact on the end-to-end delay.

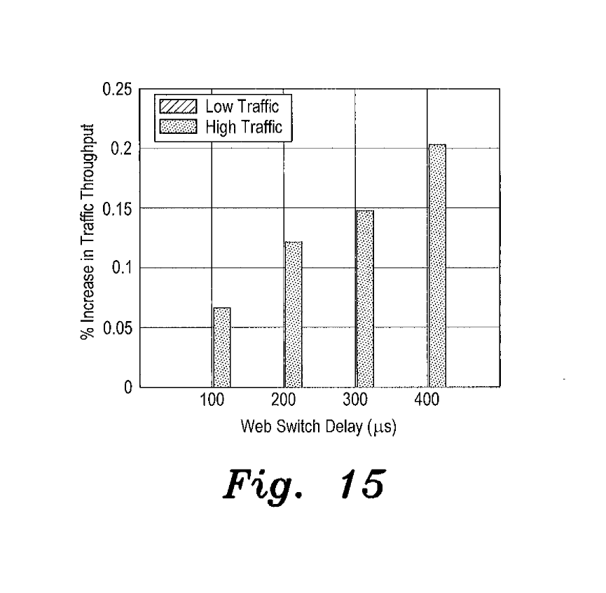

The other measure of performance considered is throughput, which is the amount of traffic received on the server side. The simulations showed no impact on the traffic throughput in the low traffic load scenario. However, the impact starts to appear in the high traffic load scenario, as shown in FIG. 14. As shown in FIG. 14, the throughput starts to decrease when the simulated web switch delay increases. This is because the added processing delay causes more packets to be queued in the web switch's queue. Thus, the amount of transmitted traffic is lower.

The relative amount of throughput decrease caused by the introduction of a web switch is shown in FIG. 15. The decrease is computed as (Throughput_{Router}−Throughput_{WebSwitch})/Throughput_{Router}. It should be noted that the impact on the throughput is relatively low; a maximum decrease of 0.2% of the total throughput is experienced when the web switch delay is as high as 400 μs. This decrease is very low and can be considered as negligible.

The simulation results show that the present solution for HTTP servers behind NAT does not cause any significant impact on the end-to-end delay, nor on the throughput. The simulations were performed with the worst-case scenario parameters; i.e., high NAT delay and high web switch delay. Therefore, the realistic implementation of this method on hardware would cause even less impact on the performance. Thus, it can be concluded that the present method has a negligibly small impact on the performance of the network.

It should be further noted that the web switch technique can be modified to work with other protocols that have host-information in layer-7, such as SMTP, for example. However, other types of protocols will still suffer the limitation of NAT and will not be directly reachable from the public Internet.

It is to be understood that the present invention is not limited to the embodiments described above, but encompasses any and all embodiments within the scope of the following claims.

We claim:

1. A network address translation-based method of bypassing Internet access denial, comprising the steps of:
establishing a private network having at least one local server and an internal DNS server;
linking the at least one local server and the internal DNS server to a web switch;
storing at least one DNS record associated with the at least one local server in a public DNS server;
forwarding at least one HTTP request from a client to the web switch through a network address translation router, wherein the at least one DNS record stored in the public DNS server is associated with a public IP address of the network address translation router;
initiating a TCP connection between the client and the web switch; and
forwarding the at least one HTTP request from the web switch to the at least one local server.

2. The network address translation-based method as recited in claim 1, further comprising the steps of:
reading a Host header from the at least one HTTP request following the step of initiating the TCP connection between the client and the web switch; and
resolving the Host header to an IP address associated with the at least one local server.

3. The network address translation-based method as recited in claim 2, wherein the internal DNS server performs the step of resolving the Host header to the IP address.

4. The network address translation-based method as recited in claim 3, wherein the step of forwarding the at least one HTTP request from the web switch to the at least one local server is performed using transport layer forwarding of traffic, the transport layer forwarding of traffic comprising establishing a web-switch table.

5. The network address translation-based method as recited in claim 4, wherein the transport layer forwarding of traffic further comprises adding an entry to the web-switch table after the step of resolving the Host header to the IP address, wherein said entry maps a client IP address and source port of the client to the IP address and a destination port of the at least one local server.

6. The network address translation-based method as recited in claim 6, further comprising the step of forwarding subsequent traffic between the client and the at least one local server using the mapping of the entry in the web-switch table until the TCP connection is terminated.

7. The network address translation-based method as recited in claim 6, further comprising the step of deleting the entry from the web-switch table after a pre-set timeout period.

8. The network address translation-based method as recited in claim 6, further comprising the step of deleting the entry from the web-switch table upon termination of the TCP connection.

9. The network address translation-based method as recited in claim 1, wherein said network address translation-based method of bypassing Internet access denial is scalable.

10. A network address translation-based method of bypassing Internet access denial, comprising the steps of:
establishing a private network having at least one local server and an internal DNS server;
linking the at least one local server and the internal DNS server to at least one web switch configured for performing network address translation routing;
storing at least one DNS record associated with the at least one local server in a public DNS server;
forwarding at least one HTTP request from a client to the at least one web switch and performing network address translation routing, wherein the at least one DNS record stored in the public DNS server is associated with a public IP address of the at least one network address translation routing web switch;
initiating a TCP connection between the client and the at least one web switch; and
forwarding the at least one HTTP request from the at least one web switch to the at least one local server.

11. The network address translation-based method as recited in claim 10, further comprising the step of reading a Host header from the at least one HTTP request following the step of initiating the TCP connection between the client and the at least one web switch.

12. The network address translation-based method as recited in claim 11, further comprising the step of resolving the Host header to an IP address associated with the at least one local server.

13. The network address translation-based method as recited in claim 12, wherein the internal DNS server performs the step of resolving the Host header to the IP address.

14. The network address translation-based method as recited in claim 13, wherein the step of forwarding the at least one HTTP request from the at least one web switch to the at least one local server is performed using transport layer forwarding of traffic.

15. The network address translation-based method as recited in claim 14, wherein the transport layer forwarding of traffic comprises establishing a web-switch table.

16. The network address translation-based method as recited in claim 15, wherein the transport layer forwarding of traffic further comprises adding an entry to the web-switch table after the step of resolving the Host header to the IP address, wherein said entry maps a client IP address and source port of the client to the IP address and a destination port of the at least one local server.

17. The network address translation-based method as recited in claim 16, further comprising the step of forwarding subsequent traffic between the client and the at least one local server using the mapping of the entry in the web-switch table until the TCP connection is terminated.

18. The network address translation-based method as recited in claim 17, further comprising the step of deleting the entry from the web-switch table after a pre-set timeout period.

19. The network address translation-based method as recited in claim 17, further comprising the step of deleting the entry from the web-switch table upon termination of the TCP connection.

20. A network address translation-based method of bypassing Internet access denial, comprising the steps of:
establishing a private network having at least one local client;
linking the at least one local client to at least one network address translation router;
forwarding at least one HTTP request from the at least one local client to the at least one network address translation router;
initiating a TCP connection between the at least one local client and the at least one network address translation router; and
forwarding the at least one HTTP request from the at least one network address translation router to a remote server outside the private network.
